(19) United States
(12) Patent Application Publication
(10) Pub. No.: US 2009/0207116 A1
(43) Pub. Date: Aug. 20, 2009

(54) LIQUID CRYSTAL DISPLAY

(76) Inventors: Soon Joon Rho, Suwon-si (KR); Jang-Sub Kim, Suwon-si (KR); Baek-Kyun Jeon, Yongin-si (KR); Hyeok-Jin Lee, Seongnam-si (KR); Hong-Jo Park, Suwon-si (KR); Min-Sik Jung, Seoul (KR); Jae-Chang Kim, Dongrae-gu (KR); Tae-Hoon Yoon, Haewoondae-gu (KR); Phil-Kook Son, Suyeong-gu (KR); Jeung-Hun Park, Haman-gun (KR)

Correspondence Address: F. CHAU & ASSOCIATES, LLC, 130 WOODBURY ROAD, WOODBURY, NY, 11797, US

(21) Appl. No.: 12/350,527

(22) Filed: Jan. 8, 2009

(30) Foreign Application Priority Data
Feb. 14, 2008 (KR) 10-2008-0013322

(51) Int. Cl. G09G 3/36

(52) U.S. Cl. 345/94

(57) ABSTRACT

A liquid crystal display includes a first substrate, a first field generating electrode formed on the first substrate, a second substrate facing the first substrate, a second field generating electrode formed on the second substrate, and a liquid crystal layer formed between the first field generating electrode and the second field generating electrode, wherein at least one of the first field generating electrode and the second field generating electrode includes zinc aluminum oxide (ZAO), and the driving voltage is in a range of about 3.7 volts to about 5.6 volts for a transmittance of 90% (T₉₀).

### CROSS-REFERENCE TO RELATED APPLICATION

This application claims priority to and the benefit of Korean Patent Application No. 10-2008-0013322 filed in the Korean Intellectual Property Office on Feb. 14, 2008, the entire contents of which are incorporated herein by reference.

### BACKGROUND OF THE INVENTION

(a) Technical Field

The present invention relates to a liquid crystal display.

(b) Discussion of the Related Art

Liquid crystal displays (LCDs) are one of the most widely used flat panel displays. A liquid crystal display has two display panels on which field generating electrodes are formed, and a liquid crystal layer that is interposed between the panels. In the liquid crystal display, a voltage is applied to the field generating electrodes so as to generate an electric field, and then the alignment of liquid crystal molecules of the liquid crystal layer is determined by the electric field. Accordingly, the transmittance of light passing through the liquid crystal layer is controlled.

In the liquid crystal display, liquid crystals rotate due to an electric field generated between the pair of field generating electrodes to change the light transmittance, and images are displayed in response to the change of light transmittance. The pair of field generating electrodes may be a pixel electrode and a common electrode, the electric field generated between the pixel electrode and the common electrode is controlled by the pixel electrode, and the voltage of the pixel electrode is controlled by a switching element such as a thin film transistor (TFT).

Since the liquid crystal display is a non-emissive element, light from inside or outside of the liquid crystal display is provided. For this purpose, a light source such as a backlight unit is provided on a rear surface of the thin film transistor array panel, and the light provided from the light source passes through the pixel electrode, the liquid crystal layer, and the common electrode, and is then transmitted to the outside.

The light provided from the light source passes through several thin films of the liquid crystal display such that the degree of transmittance is decreased and a small amount of the light provided from the light source is finally transmitted.

The transmittance of the light relates to the transmittance of each thin film including the pixel electrode and the common electrode. When the transmittance of each thin film is high, higher luminance may be obtained with the same or lower driving voltages, than when the transmittance of each thin film is low.

### SUMMARY OF THE INVENTION

The embodiments of the present invention realize higher luminances using lower driving voltages by increasing the transmittance of a liquid crystal display.

A liquid crystal display according to an exemplary embodiment of the present invention includes a first substrate, a first field generating electrode formed on the first substrate, a second substrate facing the first substrate, a second field generating electrode formed on the second substrate, and a liquid crystal layer formed between the first field generating electrode and the second field generating electrode, wherein at least one of the first field generating electrode and the second field generating electrode includes zinc aluminum oxide (ZAO), and the driving voltage is in a range of about 3.7 volts to about 5.6 volts for a transmittance of 90% (T₉₀).

The liquid crystal display may further include an alignment layer including silicon oxide (SiOx) formed on at least one of the first field generating electrode and the second field generating electrode.

The driving voltage V₁₀ of the liquid crystal display may be in a range of about 0.9 volts to about 2.5 volts for a transmittance of 10% (T₁₀).

The liquid crystal layer may include liquid crystal molecules having different optical anisotropy according to the intensity of the electric field between the first field generating electrode and the second field generating electrode.

The liquid crystal molecule may exhibit optical isotropy in the absence of the electric field between the first field generating electrode and the second field generating electrode, and exhibit optical anisotropy under the application of the electric field between the first field generating electrode and the second field generating electrode.

A total transmittance for a visible ray region of light may be in a range of about 89.5% to about 92.7%.

A liquid crystal display according to an exemplary embodiment of the present invention includes a first substrate, a first field generating electrode formed on the first substrate, a second substrate facing the first substrate, a second field generating electrode formed on the second substrate, an alignment layer including silicon oxide (SiOx) formed on at least one of the first field generating electrode and the second field generating electrode, and a liquid crystal layer formed between the first field generating electrode and the second field generating electrode, wherein the driving voltage is in a range of about 3.7 volts to about 5.6 volts for a transmittance of 90% (T₉₀).

The driving voltage V₁₀ of the liquid crystal display may be in a range of about 0.9 volts to about 2.5 volts for a transmittance of 10% (T₁₀).

The liquid crystal layer may include liquid crystal molecules having different optical anisotropy according to the intensity of the electric field between the first field generating electrode and the second field generating electrode.

The liquid crystal molecules may exhibit optical isotropy in the absence of the electric field between the first field generating electrode and the second field generating electrode, and exhibit optical anisotropy under the application of the electric field between the first field generating electrode and the second field generating electrode.

A liquid crystal display according to an exemplary embodiment of the present invention includes a first substrate, a first field generating electrode formed on the first substrate, a second substrate facing the first substrate, a second field generating electrode formed on the second substrate, and a liquid crystal layer formed between the first field generating electrode and the second field generating electrode, wherein at least one of the first field generating electrode and the second field generating electrode includes zinc aluminum oxide, and the liquid crystal layer includes liquid crystal molecules having different optical anisotropy according to the intensity of the electric field between the first field generating electrode and the second field generating electrode.

The driving voltage may be in a range of about 3.7 volts to about 5.6 volts with for a transmittance of 90% (T₉₀).

The driving voltage V₁₀ of the liquid crystal display may be in a range of about 0.9 volts to about 2.5 volts for a transmittance of 10% (T₁₀).

The liquid crystal molecules may represent optical isotropy in the absence of the electric field between the first field generating electrode and the second field generating electrode, and exhibit optical anisotropy under the application of the electric field between the first field generating electrode and the second field generating electrode.

A total transmittance for a visible ray region of light may be in a range of about 89.5% to about 92.7%.

According to an exemplary embodiment of the present invention, the transmittance may be increased, the driving voltage may be reduced to obtain the same luminance, and the luminance may be increased when using the same driving voltage.

### BRIEF DESCRIPTION OF THE DRAWINGS

FIG. 1 is an equivalent circuit diagram of a unit pixel in a liquid crystal display;

FIG. 2 is a layout view of a liquid crystal display according to an exemplary embodiment of the present invention;

FIG. 3 is a cross-sectional view of the liquid crystal display shown in FIG. 2 taken along the lines III-III′-III″-III′″;

FIG. 4 to FIG. 6 are graphs showing the transmittances according to the kinds of the transparent electrodes and/or alignment layers for the visible ray region in the liquid crystal display according to exemplary embodiments of the present invention;

FIG. 7 is a graph showing the relationship of driving voltage and transmittance according to kinds of transparent electrodes and alignment layers, according to exemplary embodiments of the present invention; and

FIG. 8 is a graph showing the relationship of driving voltage and luminance according to kinds of transparent electrodes and alignment layers, according to embodiments of the present invention.

### DETAILED DESCRIPTION OF THE EMBODIMENTS

The present invention will be described more fully hereinafter with reference to the accompanying drawings, in which exemplary embodiments of the invention are shown. As those skilled in the art would realize, the described embodiments may be modified in various different ways without departing from the spirit or scope of the present invention.

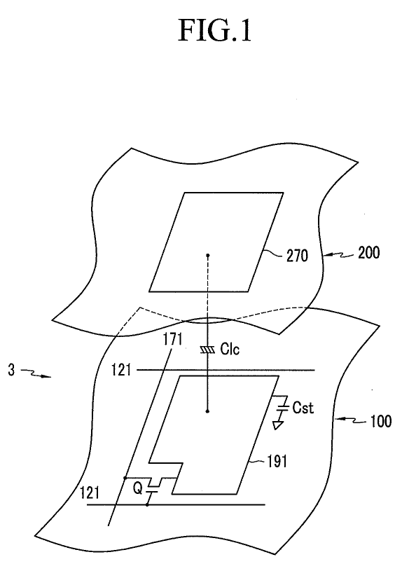

In the drawings, the thickness of layers, films, panels, regions, etc., may be exaggerated for clarity. Like reference numerals may designate like elements throughout the specification. It will be understood that when an element such as a layer, film, region, or substrate is referred to as being “on” another element, it can be directly on the other element or intervening elements may also be present. A liquid crystal display according to an exemplary embodiment of the present invention will be described with reference to FIG. 1 to FIG. 3.

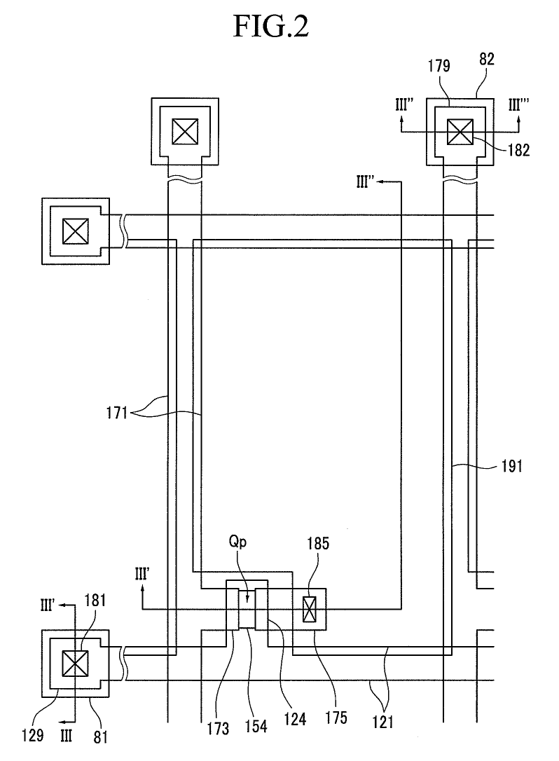

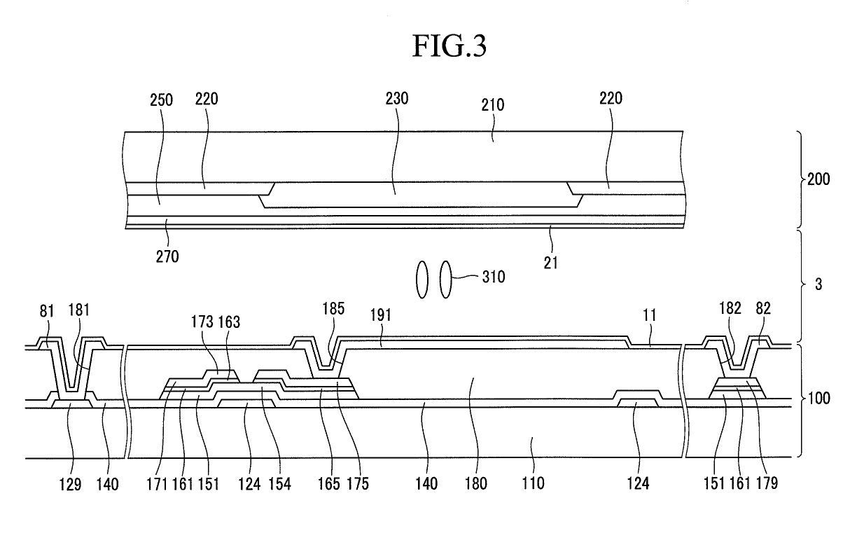

FIG. 1 is an equivalent circuit diagram of an unit pixel in a liquid crystal display, FIG. 2 is a layout view of a liquid crystal display according to an exemplary embodiment of the present invention, and FIG. 3 is a cross-sectional view of the liquid crystal display shown in FIG. 2 taken along the lines III-III′-III″-III′″.

Referring to FIG. 1, the liquid crystal display includes a plurality of signal lines 121 and 171, and a plurality of pixels connected thereto and arranged in an approximate matrix shape. The liquid crystal display includes a lower panel 100 and an upper panel 200, which are positioned opposite to each other, and a liquid crystal layer 3 formed therebetween.

The signal lines 121 and 171 include a plurality of gate lines 121 for transferring gate signals (also referred to as scan signals), and a plurality of data lines 171 for transferring data signals. The gate lines 121 extend substantially in a row direction and are substantially parallel to each other, and the data lines 171 extend substantially in a column direction and are substantially parallel to each other.

Each pixel includes a switching element Qp connected to the signal lines 121 and 171, and a liquid crystal capacitor Clc and a storage capacitor Cst. The storage capacitor Cst can be omitted if necessary.

The switching element Qp is a three-terminal element such as a thin film transistor (TFT), and is provided on the lower panel 100, which includes a control terminal connected with the gate lines 121, an input terminal connected with the data lines 171, and an output terminal connected with the liquid crystal capacitor Clc and the storage capacitor Cst.

The liquid crystal capacitor Clc has a pixel electrode 191 of the lower panel 100 and a common electrode 270 of a upper panel 200 as its two terminals, and the liquid crystal layer 3 between the two electrodes 191 and 270 serves as a dielectric material. The pixel electrode 191 is connected with the switching element Qp, and the common electrode 270 receives a common voltage Vcom.

Next, the structure of the liquid crystal display of FIG. 1 will be described in further detail with the reference to FIG. 2 and FIG. 3.

In connection with the lower panel 100, a plurality of gate lines 121 for transmitting gate signals is formed on an insulating substrate 110. Each gate line 121 includes a plurality of gate electrodes 124 projecting upward and an end portion 129 having a large area for connection with an external circuit.

A gate insulating layer 140 is formed on the gate lines 121, and a plurality of semiconductor stripes 151, for example, made of hydrogenated amorphous silicon (abbreviated to “a-Si”) or polysilicon, are formed in a vertical direction on the gate insulating layer 140. The semiconductor stripes 151 include a plurality of protrusions 154 extending toward the gate electrodes 124.

A plurality of ohmic contact stripes 161 and a plurality of ohmic contact islands 165, for example, made of silicide or n+ hydrogenated amorphous silicon (a-Si) heavily doped with an n-type impurity such as phosphorus (P), are formed on the semiconductor stripes 151. The ohmic contact stripes 161 include a plurality of protrusions 163 extending toward the protrusions 154 of the semiconductor stripes 151, and the protrusions 163 and the ohmic contact islands 165 are disposed in pairs on the protrusions 154 of the semiconductor stripes 151.

A plurality of data lines 171 and a plurality of drain electrodes 175 are formed on the ohmic contact stripes 161, the ohmic contact islands 165, and the gate insulating layer 140.

The data lines 171 extending substantially in the longitudinal direction intersect the gate lines 121 and the storage electrode lines 131, and transmit data signals. Each of the data lines 171 includes a plurality of source electrodes 173 branched out toward the gate electrodes 124, and a source electrode 173 and a drain electrode 175 forming a pair are positioned opposite to each other on the gate electrode 124.

The gate electrode 124, the source electrode 173, and the drain electrode 175 form a thin film transistor (TFT) along with the semiconductor stripe 151. The channel of the thin film transistor is located on the protrusion 154 of the semiconductor stripe 151 between the source electrode 173 and the drain electrode 175.

The semiconductor stripes 151 except for the channel regions between the source electrode 173 and the drain electrode 175 have substantially the same planar shape as the data lines 171 and the drain electrodes 175.

The ohmic contact stripes 161 are interposed between the semiconductor stripes 151 and the data lines 171, and have substantially the same planar shape as the data lines 171. The ohmic contact islands 165 are interposed between the semiconductor stripes 151 and the drain electrodes 175, and have substantially the same planar shape as the drain electrode 175.

A passivation layer 180 is formed on the data lines 171 and the drain electrodes 175. The passivation layer 180 may be made of an inorganic insulating material such as silicon nitride or silicon oxide, or an organic insulating material such as an acryl-based compound.

The passivation layer 180 has a plurality of contact holes 185 and 182 respectively exposing the drain electrodes 175 and end portions 179 of the data lines 171. The passivation layer 180 and the gate insulating layer 140 have a plurality of contact holes 181 respectively exposing the end portions 129 of the gate lines 121.

A plurality of pixel electrodes 191 and a plurality of contact assistants 81 and 82 are formed on the passivation layer 180.

The pixel electrodes 191 are physically and electrically connected to the drain electrodes 175 through the contact holes 185 and are supplied with data voltages from the drain electrodes 175.

The contact assistants 81 and 82 are connected through the contact holes 181 and 182 to the end portions 129 of the gate lines 121 and the end portions 179 of the data lines 171, respectively. The contact assistants 81 and 82 enhance protection of and the adhesion of the exposed end portions 129 and 179 of the gate lines 121 and the data lines 171 to external apparatuses.

The pixel electrodes 191 and the contact assistants 81 and 82 may be made of zinc aluminum oxide (ZAO). The zinc aluminum oxide is a transparent conductive oxide and may be in a form in which aluminum (Al) is coated on zinc oxide (ZnOx), for example in a ratio of zinc (Zn) to aluminum (Al) to oxygen (O) of 49:2:49. The zinc aluminum oxide has higher transmittance than indium tin oxide (ITO), the material used for conventional transparent electrodes.

In connection with the the upper panel 200, a plurality of light blocking members 220 that are separated from each other by a predetermined interval are formed on an insulating substrate 210. The light blocking members 220 are also referred to as black matrixes and they prevent light leakage.

A plurality of color filters 230, an overcoat 250, and a common electrode 270 are formed on the light blocking members 220.

The common electrode 270 also may be made of zinc aluminum oxide (zinc aluminum oxide, ZAO), like the pixel electrodes 191. The zinc aluminum oxide is a transparent conductive oxide and may be in a form in which aluminum (Al) is coated on zinc oxide (ZnOx), for example in a ratio of zinc (Zn) to aluminum (Al) to oxygen (O) of 49:2:49.

In the present exemplary embodiment, an example in which both of the pixel electrode 191 and the common electrode 270 are made of the zinc aluminum oxide (ZAO) will be described. Alternatively, only one of the pixel electrode 191 and the common electrode 270 may be made of zinc aluminum oxide (ZAO), and the other may be made of an indium oxide such as ITO or IZO.

Alignment layers 11 and 21 are formed on the inner surfaces of the lower panels 100 and the upper panel 200.

The alignment layers 11 and 21 may be made of silicon oxide (SiOx). The silicon oxide has higher material stability and a higher transmittance than polyimide that is used as a material for conventional alignment layers.

A liquid crystal layer 3 including a plurality of liquid crystal molecules 310 is formed between the lower panel 100 and the upper panel 200. The liquid crystal layer 3 is in a state of negative dielectric anisotropy, and liquid crystal molecules 310 are aligned such that their long axes are substantially parallel to the surfaces of the panels 100 and 200 in the absence of an electric field, and are rearranged in a predetermined direction under the generation of an electric field between the common electrode 270 and the pixel electrode 191. The liquid crystal molecules 310 may be subject to a Van der Waals interaction with alignment layers made of the silicon oxide to form a pretilt angle.

As described above, according to an exemplary embodiment of the present invention, the pixel electrodes 191 and the common electrode 270 (referred to as “transparent electrodes”) are made of zinc aluminum oxide (ZAO).

The zinc aluminum oxide (ZAO) has higher transmittance in the visible ray region such that the transmittance may be improved for the light provided from the light source such as a backlight, and accordingly higher luminance may be obtained with the application of the same driving voltage as in a conventional LCD and a lower driving voltage may result in the same luminance as when a higher driving voltage is applied in a conventional LCD.

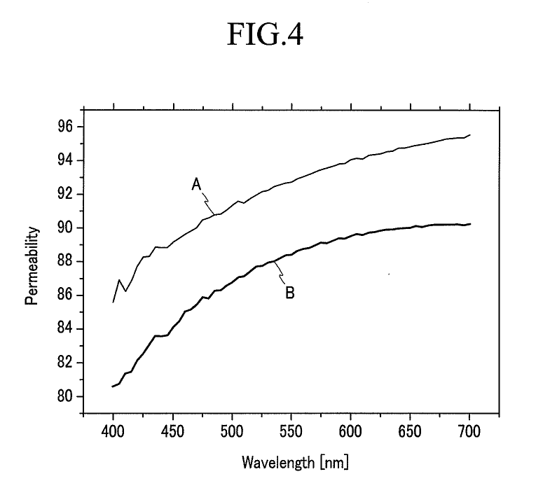

The transmittance and the driving voltage will be described in further detail with reference to FIG. 4 to FIG. 8.

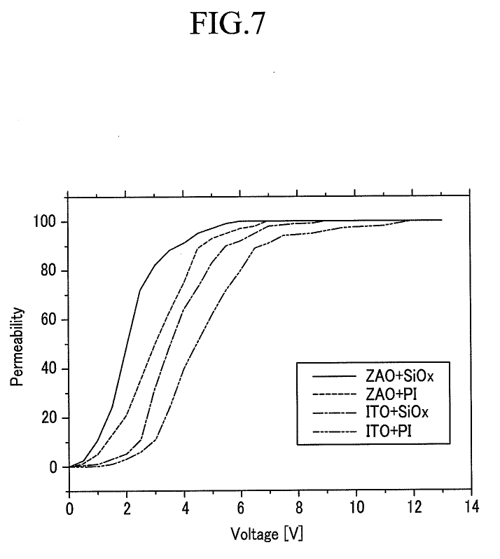

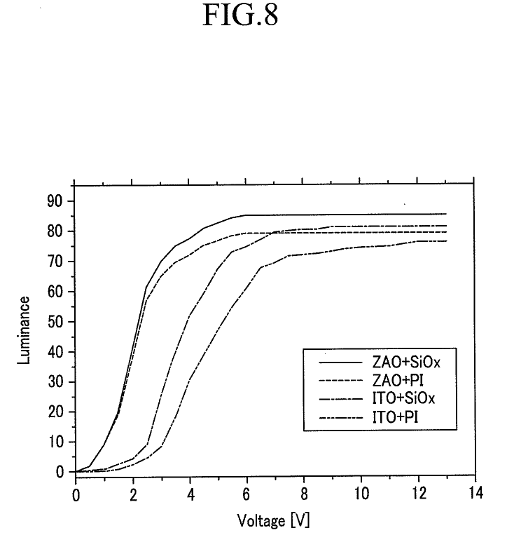

FIG. 4 to FIG. 6 are graphs showing the transmittances according to the kinds of the transparent electrodes and/or alignment layers for the visible ray region in the liquid crystal display according to embodiments of the present invention. FIG. 7 is a graph showing the relationship of the driving voltage and the transmittance according to kinds of the transparent electrodes and the alignment layers, and FIG. 8 is a graph showing the relationship of the driving voltage and the luminance according to kinds of the transparent electrodes and the alignment layers.

Referring to FIG. 4, “A” indicates light transmittance of a liquid crystal display including a transparent electrode made of zinc aluminum oxide (ZAO), and “B” is light transmittance of a liquid crystal display including a transparent electrode made of ITO.

As shown in the graph, the liquid crystal display A including the transparent electrode made of zinc aluminum oxide (ZAO) has higher transmittance than the liquid crystal display B including the transparent electrode made of ITO for the same wavelengths. In detail, the liquid crystal display B including the transparent electrode of ITO has total transmittance of about 87.4% in the visible ray region (about 400 to 700 nm), whereas the total transmittance is about 92.2% in the visible ray region in the case A of the zinc aluminum oxide (ZAO), which is higher.

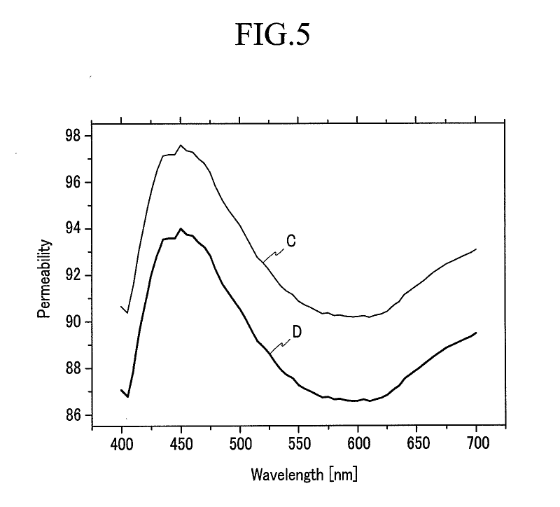

Referring to FIG. 5, “C” indicates transmittance according to wavelength of a liquid crystal display including a transparent electrode made of zinc aluminum oxide (ZAO) and an alignment layer made of polyimide, and “D” indicates transmittance according to wavelength of a liquid crystal display including a transparent electrode made of ITO and an alignment layer made of polyimide.

As shown in the graphs, when the alignment layers made of polyimide are used, the liquid crystal display C including the transparent electrode of zinc aluminum oxide (ZAO) has higher transmittance than the liquid crystal display D including the transparent electrode of ITO for the same wavelengths In detail, the total transmittance is about 89.1% for the visible ray region in the case of the liquid crystal display D including the alignment layer of polyimide and the transparent electrode of ITO, whereas the total transmittance is about 92.7% for the visible ray region in the case of the liquid crystal display C including the alignment layer of polyimide and the transparent electrode of zinc aluminum oxide.

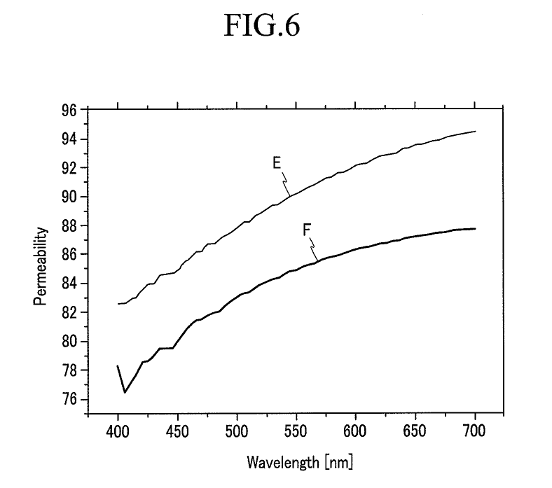

Referring to FIG. 6, “E” indicates transmittance according to wavelength of a liquid crystal display including a transparent electrode made of zinc aluminum oxide (ZAO) and an alignment layer made of silicon oxide (SiOx), and “F” indicates transmittance according to wavelength of a liquid crystal display including a transparent electrode made of ITO and an alignment layer made of silicon oxide.

As shown in the graph, the liquid crystal display E including the transparent electrode of zinc aluminum oxide (ZAO) and the alignment layer of silicon oxide has higher transmittance than the liquid crystal display F including the transparent electrode of ITO and the alignment layer of silicon oxide. In detail, the total transmittance is about 84.0% for the visible ray region in the case of the liquid crystal display F including the alignment layer of silicon oxide and the transparent electrode of ITO, whereas the total transmittance is about 89.5% for the visible ray region in the case of the liquid crystal display E including the alignment layer of silicon oxide and the transparent electrode of zinc aluminum oxide.

The voltage characteristics of the above described liquid crystal displays with the transmittances “C”, “D”, “E”, and “F” will be described in further detail with reference to Table 1, and FIG. 7 and FIG. 8.

Table 1 shows the results of measuring the relationship of the driving voltage and the transmittance according to the kinds of transparent electrodes and alignment layers.

TABLE 1

| | | Driving voltage | | Driving voltage | |
|---|---|---|---|---|---|
| Transparent | Alignment | | Relative | | Relative |
| electrode | layer | V10 | fraction (%) | V90 | fraction (%) |
| ITO | Polyimide | 2.95 | 100 | 6.74 | 100 |
| | (PI) | | | | |
| | Silicon oxide | 2.42 | 82 | 5.56 | 82.5 |
| | (SiOx) | | | | |
| ZAO | Polyimide | 1.00 | 33.9 | 4.42 | 65.6 |
| | (PI) | | | | |
| | Silicon oxide | 0.93 | 31.5 | 3.79 | 56.2 |
| | (SiOx) | | | | |

In Table 1, V₁₀ and V₉₀ are values of driving voltages respectively corresponding to the transmittances of 10% and 90% in the graph of FIG. 7, and a lower value indicates a lower driving voltage. The transmittance of 10% represents a black characteristic, and the transmittance of 90% represents a white characteristic.

Referring to Table 1 and FIG. 7, when using alignment layers of the same material, the driving voltage of the liquid crystal display including the transparent electrode of zinc aluminum oxide (ZAO) required to achieve a certain transmittance or luminance is lower than that of the liquid crystal display including the transparent electrode of ITO. Also, when using transparent electrodes of the same material, the driving voltage of the liquid crystal display including the alignment layer of silicon oxide (SiOx) required to achieve a certain transmittance or luminance is lower than that of the liquid crystal display including the alignment layer of polyimide.

The range of the driving voltage V₉₀ corresponding to the transmittance of 90% in the liquid crystal display including the transparent electrode of zinc aluminum oxide (ZAO) or the alignment layer of silicon oxide (SiOx), or the liquid crystal display including both, is about 3.7V to about 5.6V, thereby obtaining a lower driving voltage than when ZAO and/or SiOx is not used. Also, the range of the driving voltage V₁₀ corresponding to the transmittance of 10% in this liquid crystal display is about 0.9V to about 2.5V, thereby obtaining a lower driving voltage than when ZAO and/or SiOx is not used.

FIG. 8 is a graph converting the transmittance of FIG. 7 into luminance, and when using alignment layers of the same material, the driving voltage of the liquid crystal display including the transparent electrode of zinc aluminum oxide (ZAO) becomes lower to represent the same luminance, compared with the liquid crystal display including the transparent electrode of ITO. Also, when using the transparent electrodes of the same material, the liquid crystal display including the alignment layer made of silicon oxide (SiOx) has a lower driving voltage to represent the same luminance compared with the liquid crystal display including the alignment layer made of polyimide.

Likewise, when using the alignment layers of the same material, the liquid crystal display including the transparent electrode of zinc aluminum oxide (ZAO) exhibits a higher luminance than that of the liquid crystal display including the transparent electrode of ITO when using the same driving voltage. Also, when using the transparent electrode of the same material, the liquid crystal display including the alignment layer of silicon oxide (SiOx) exhibits higher luminance than that of the liquid crystal display including the alignment layer of polyimide when using the same driving voltage.

Accordingly, the transmittance may be increased, the driving voltage may be reduced to exhibit the same luminance, and the luminance may be increased for the driving voltage by using the transparent electrode of zinc aluminum oxide (ZAO) and/or the alignment layer of silicon oxide.

A liquid crystal display according to an exemplary embodiment of the present invention will be described.

The present exemplary embodiment includes substantially the same structure as the previous exemplary embodiment, however it includes different liquid crystal molecules 310 in the liquid crystal layer 3 compared with the embodiment described above.

In the embodiment described above, the liquid crystal display including the liquid crystal molecules 310 having dielectric anisotropy was described. Alternatively, the liquid crystal display according to the present exemplary embodiment includes liquid crystal molecules 310 of which the optical characteristics are changed according to the electric field between the pixel electrode 191 and the common electrode 270.

The liquid crystal molecules 310 applied to the present exemplary embodiment exhibit optical isotropy in the absence of an electric field, and the optical anisotropy is exhibited under the application of an electric field between the pixel electrode 191 and the common electrode 270, wherein the magnitude of the optical anisotropy is changed according to the intensity of the electric field.

Accordingly, the liquid crystal molecules 310 are arranged between the two display panels 100 and 200 in a disorderly fashion without a specific direction in the absence of the electric field between the pixel electrode 191 and the common electrode 270. During application of the electric field between the pixel electrode 191 and the common electrode 270, the liquid crystal molecules 310 are arranged perpendicularly to the generation direction of the electric field.

The liquid crystal molecules having the optical anisotropy change the alignment by rotation of the liquid crystal molecules according to the application of the electric field to display images, and the response speed is determined by the original viscosity of the liquid crystal molecules. In contrast, the optical anisotropic characteristics of the liquid crystal molecules according to an exemplary embodiment of the present invention is determined according to the application of the electric field, and the magnitude of the optical anisotropy is also changed according to the intensity of the electric field to display the images such that the original viscosity of the liquid crystal molecules is irrelevant. Accordingly, high response speed may be realized regardless of the original viscosity of the liquid crystal molecules.

These liquid crystal molecules 310 may include a material having a liquid crystal phase that is referred to as a blue phase. The blue phase has a narrow temperature range between an isotropic phase and a cholesteric phase such that the optical isotropy is represented in the absence of the electric field and the optical anisotropy is represented under the application of the electric field.

Like the above described exemplary embodiments, when the transparent electrode made of zinc aluminum oxide (ZAO) and/or the alignment layer made of silicon oxide are included when using the liquid crystal material of this blue phase, the transmittance may be increased, and simultaneously the high speed response characteristics may be realized. Furthermore, the driving voltage to represent the same luminance may be reduced and a higher luminance may be represented through the same driving voltage when compared with an LCD not using the ZAO and/or SiOx.

While this invention has been described in connection with exemplary embodiments, it will be apparent to those skilled in the art that various modifications and changes may be made thereto without departing from the scope and spirit of the invention. Accordingly, it is to be understood that the invention is not limited to the disclosed embodiments, and is intended to cover various modifications and equivalent arrangements included within the spirit and scope of the appended claims.

What is claimed is:

1. A liquid crystal display comprising:
a first substrate;
a first field generating electrode formed on the first substrate;
a second substrate facing the first substrate;
a second field generating electrode formed on the second substrate; and
a liquid crystal layer formed between the first field generating electrode and the second field generating electrode,
wherein at least one of the first field generating electrode and the second field generating electrode includes zinc aluminum oxide (ZAO), and
a driving voltage of the liquid crystal display is in a range of about 3.7 V to about 5.6 V for a transmittance of 90% (T₉₀).

2. The liquid crystal display of claim 1, further comprising
an alignment layer formed on at least one of the first field generating electrode and the second field generating electrode and including silicon oxide (SiOx).

3. The liquid crystal display of claim 2, wherein
the driving voltage of the liquid crystal display is in a range of about 0.9 V to about 2.5 V for a transmittance of 10% (T₁₀).

4. The liquid crystal display of claim 2, wherein
the liquid crystal layer includes liquid crystal molecules having different optical anisotropy according to an intensity of an electric field between the first field generating electrode and the second field generating electrode.

5. The liquid crystal display of claim 4, wherein
the liquid crystal molecules exhibit optical isotropy in the absence of the electric field between the first field generating electrode and the second field generating electrode, and
the liquid crystal molecules exhibit optical anisotropy under the application of the electric field between the first field generating electrode and the second field generating electrode.

6. The liquid crystal display of claim 1, wherein a total transmittance for a visible ray region of light is in a range of about 89.5% to about 92.7%.

7. A liquid crystal display comprising:
a first substrate;
a first field generating electrode formed on the first substrate;
a second substrate facing the first substrate;
a second field generating electrode formed on the second substrate;
an alignment layer formed at least one of the first field generating electrode and the second field generating electrode, and including silicon oxide (SiOx); and
a liquid crystal layer formed between the first field generating electrode and the second field generating electrode,
wherein a driving voltage of the liquid crystal display is in a range of about 3.7 V to about 5.6 V for a transmittance of 90% (T₉₀).

8. The liquid crystal display of claim 7, wherein
the driving voltage of the liquid crystal display is in a range of about 0.9 V to about 2.5 V for a transmittance of 10% (T₁₀).

9. The liquid crystal display of claim 8, wherein
the liquid crystal layer includes liquid crystal molecules having different optical anisotropy according to an intensity of an electric field between the first field generating electrode and the second field generating electrode.

10. The liquid crystal display of claim 9, wherein
the liquid crystal molecules exhibit optical isotropy in the absence of the electric field between the first field generating electrode and the second field generating electrode, and
the liquid crystal molecules exhibit optical anisotropy under the application of the electric field between the first field generating electrode and the second field generating electrode.

11. A liquid crystal display comprising:
a first substrate;
a first field generating electrode formed on the first substrate;
a second substrate facing the first substrate;
a second field generating electrode formed on the second substrate; and
a liquid crystal layer formed between the first field generating electrode and the second field generating electrode,
wherein at least one of the first field generating electrode and the second field generating electrode includes zinc aluminum oxide, and
the liquid crystal layer includes liquid crystal molecules having different optical anisotropy according to an intensity of an electric field between the first field generating electrode and the second field generating electrode.

12. The liquid crystal display of claim 11, wherein
a driving voltage of the liquid crystal display is in a range of about 3.7 V to about 5.6 V for a transmittance of 90% (T₉₀).

13. The liquid crystal display of claim 12, wherein
the driving voltage of the liquid crystal display is in a range of about 0.9 V to about 2.5 V for a transmittance of 10% (T₁₀).

14. The liquid crystal display of claim 11, wherein
the liquid crystal molecules exhibit optical isotropy in the absence of the electric field between the first field generating electrode and the second field generating electrode, and
the liquid crystal molecules exhibit optical anisotropy under the application of the electric field between the first field generating electrode and the second field generating electrode.

15. The liquid crystal display of claim 11, wherein a total transmittance for a visible ray region of light is in a range of about 89.5% to about 92.7%.
